(19) United States
(12) Patent Application Publication
(10) Pub. No.: US 2018/0084759 A1
(43) Pub. Date: Mar. 29, 2018

(54) PET TREAT DISPERSER DEVICE

(71) Applicant: Yvonne Marlowe, Miami, FL (US)

(72) Inventor: Yvonne Marlowe, Miami, FL (US)

(21) Appl. No.: 15/276,793

(22) Filed: Sep. 27, 2016

(51) Int. Cl. A01K 15/02

(52) U.S. Cl. CPC A01K 15/026

(57) ABSTRACT

A toy device to disperse a pet treat comprises a body having an upper section and a lower section fixedly attached to each other via an interconnecting assembly. The upper section is a lid assembly configured to have an adjustable section to releasably cover the lower section. The lower section comprises a mesh member defining a hollow section to store and disperse a plurality of treats. The hollow section of the mesh member is chewed on by the pets to dissolve the treats stored in the mesh member.

### BACKGROUND

Pet animals are an integral part of each and every house. Pet care is an important factor to keep the pets mentally and physically strong. Numerous methods and solutions have been attempted to provide better care for these pets. One of the most common solutions is providing a pet toy to keep the pets interactive throughout the day as well as to maintain good health. If the pets are really active, they are less prone to negative behaviors and stress. Therefore, the pet toys that are made of a chew or an edible treat are used to provide a plurality of benefits. However, eventually pets start consuming it completely and lose interest.

In certain cases, the toys comprise a cavity to hold treats for pets. Whenever the pets start playing with the toys, the treats are dispersed at various rates. The effective dispersion of treats for the pets on all occasions is very minimal. Further, the cumbersome design of these toys does not allow the pets to be interactive for any longer period of time. Also if these toys are not properly cleaned, it may pose numerous health issues for the pets.

Prior art reference U.S. Pat. No. 8,474,404 discloses a pet toy with adjustable treat dispensing lid wherein the treats are selectively dispersed in different sized and shaped treats/food and at varying rates. However, the design is cumbersome and does not keep the pets interactive for longer periods.

In light of the aforementioned drawbacks and limitations, there exists a need for a toy device to administer treats for pets in a fun and interactive way.

### SUMMARY

The objective of the present invention is to provide a toy device to disperse a pet treat in a fun and interactive way and also to keep the pets interactive for a longer period of time while administering the treats.

According to one embodiment of the present invention, the toy device comprises a body having an upper section and a lower section fixedly attached to each other via an interconnecting assembly. The upper section is a lid assembly configured to have an adjustable section to releasably cover the lower section. The lower section comprises a mesh member defining a hollow section to store and disperse a plurality of treats.

According to one embodiment of the present invention, the upper section comprises an annular member fixedly attached to the lid assembly. The annular member is configured to have a polymer sheath positioned along the circumference of the annular member to allow the pet to bite the device without discomfort.

### BRIEF DESCRIPTIONS OF SEVERAL VIEWS OF DRAWINGS

FIG. 1 illustrates a front view of a toy device to disperse a pet treat, according to an embodiment of the present invention.

FIG. 2 illustrates the front view of the toy device dispersing a plurality of treats, according to another embodiment of the present invention.

### DETAILED DESCRIPTION OF DIFFERENT EMBODIMENTS

The present invention is related to a toy device 100 to disperse a pet treat in a fun way to keep the pets interactive for a longer period of time.

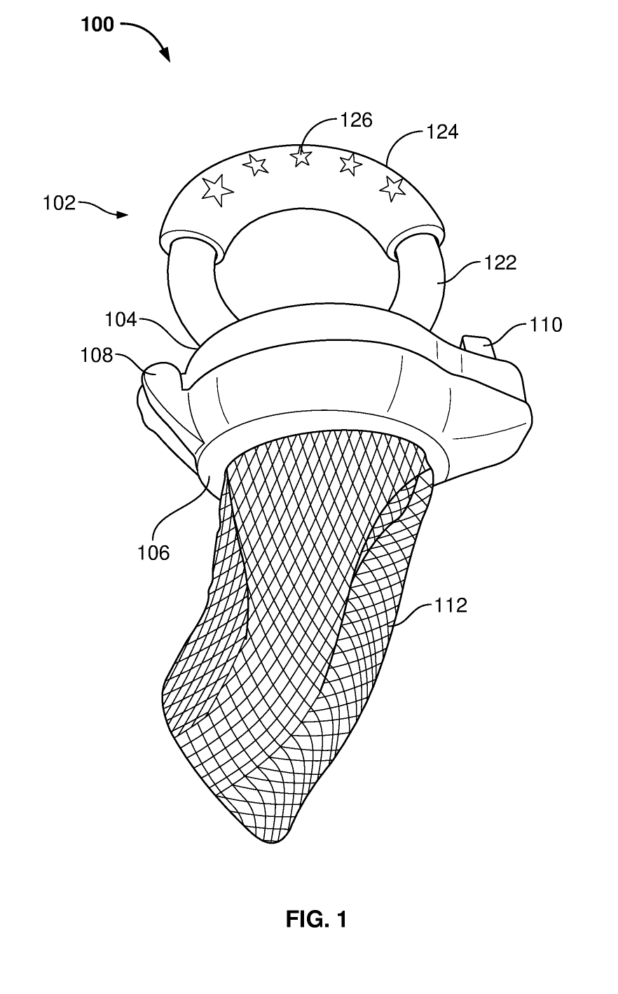

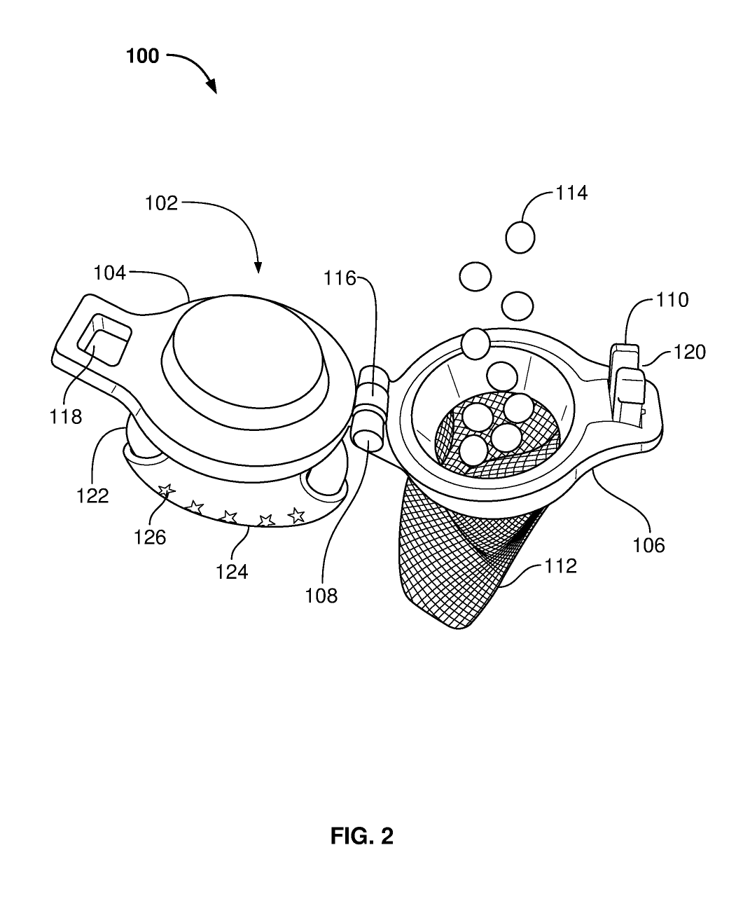

FIG. 1 illustrates a perspective view of a toy device 100. The toy device 100 comprises a body 102 having an upper section 104 and a lower section 106 fixedly attached to each other via an interconnecting assembly 108. The upper section 104 is a lid assembly configured to have an adjustable section 110 to releasably cover the lower section 106 and the lower section 106 comprises a mesh member 112 defining a hollow section to store and disperse a plurality of treats 114. The interconnecting assembly 108 comprises a hinge mechanism 116 as shown in FIG. 2 to operably close the upper section 104 to cover the lower section 106 containing the treats 114. The interconnecting assembly 108 provides a frictional contact between the upper section 104 and the lower section 106 configured to selectively disperse the treats 114 whenever the pet plays with the toy device 100. The interconnecting assembly 108 further comprises a catch member 118 and a catch receiving section 120 to lock and position the upper section 104 with the lower section 106 of the toy device 100.

In an embodiment, according to the present invention as shown in FIG. 1, the upper section 104 of the toy device 100 comprises an annular member 122 fixedly attached to the lid assembly, wherein the annular member 122 is configured to have a polymer sheath 124 positioned along the circumference of the annular member 122 to allow the pet to bite and chew the device 100 without discomfort. The polymer sheath 124 of the annular member 122 comprises a plurality of symbols 126 to enhance the aesthetic appearance of the device 100. Whenever the pets start playing with the toy device 100, the configuration of the annular member 122 with symbols 126 keep the pets interactive and enhances the interest to bite and chew the toy device 100.

Referring to FIG. 1, the mesh member 112 of the lower section 106 is made of a material selected from at least one of a soft cloth, a fabric, a plastic and a polymer. The hollow section of the mesh member 112 is chewed by the pets to dissolve the treats 114 stored in the mesh member 112. Further, the mesh member 112 comprises a plurality of holes of predetermined sizes configured to prevent the treats 114 from passing through the mesh member 112 acting as a breathable member. In different embodiment, the mesh member 112 of the lower section 106 is configured to store and disperse at least one of a treat 114 and or a medical supplement. The adjustable section 110 of the upper section 104 is configured to assist in dispersing the treats 114 at different rates.

According to an exemplary embodiment as shown in FIG. 2, a method of using the toy device 100 to disperse the pet treats 114 is also disclosed. The method comprises: making the toy device 100 by a molding technique. The upper section 104 and the lower section 106 of the toy device 100 are fixedly attached to each other via an interconnecting assembly 108. The upper section 104 acts as a closing lid and the lower section 106 comprises a mesh member 112 for holding the treats 114. The hollow section of the mesh member 112 is filled with the pet treats 114 and then the toy device 100 is given to the pets for playing. The interconnecting assembly 108 provides a frictional contact between the upper section 104 and the lower section 106 configured to selectively disperse the treats 114 whenever the pet plays with the toy device 100. Therefore, when the pets is interactive with this toy device 100, the treats 114 are dispersed selectively via the releasably secured upper section 104 and the lower section 106. So the toy device 100 administers the treats to the pets as well as the pets are kept occupied while they pursue their nutrients. Optionally, a user can stop the dispersion of treats 114 by just simply closing the lid via the catch members 118 in the interconnecting assembly 108. Once the treats 114 are completely fed, it can be refilled easily by manually adjusting the interconnecting assembly 108. In a preferred embodiment, the pet animal is a dog. However, other pet animals are also considered in the different embodiments of the present invention.

In an embodiment, as shown in FIG. 2, the toy device 100 is configured to have a plurality of colors to enhance the appearance of the device 100 and also to improve the instructiveness of the pets with the toy device 100. The configuration of the toy device 100 is made in such a way that the pets are tempted to be interactive with the toy device 100. Further, the mesh member 112 of the lower section 106 comprises a breathable layer which allows the odor of the treats to induce interaction with the pets.

The toy device 100, according to the present invention, allows for an easier and fun way to administer food and medical supplements to pets. Also the pets are kept interactive with the toy device 100 during the process. The design of the toy device 100 allows the pet to stay intact with the device 100 for longer period of time. The shape and aesthetic parameters of the toy device 100 improves the appealing factor of the device 100. Using the toy device 100, the user can easily load the treats 114 in the mesh member 112 and also they can be dispersed to the pets at controlled rates depending on the requirements.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein.

I claim:

1. A toy device to disperse a pet treat, the device comprising:
a body comprising an upper section and a lower section fixedly attached to each other via an interconnecting assembly, wherein the upper section is a lid assembly configured to have an adjustable section to releasably cover the lower section, and
wherein the lower section comprises a mesh member defining a hollow section to store and disperse a plurality of treats.

2. The device of claim 1, wherein the upper section comprises an annular member fixedly attached to the lid assembly, wherein the annular member is configured to have a polymer sheath positioned along the circumference of the annular member to allow the pet to bite the device without discomfort.

3. The device of claim 2, wherein the polymer sheath of the annular member comprises a plurality of symbols to enhance the aesthetic appearance of the device.

4. The device of claim 1, wherein the mesh member is made of a material selected from at least one of a soft cloth, a fabric, a plastic and a polymer.

5. The device of claim 1, wherein the hollow section of the mesh member is chewed by the pets to dissolve the treats stored in the mesh member.

6. The device of claim 1, wherein the mesh member comprises a plurality of holes of predetermined sizes configured to prevent the treats from passing through the mesh member.

7. The device of claim 1, wherein the interconnecting assembly comprises a hinge mechanism to operably close the upper section to cover the lower section containing the treats.

8. The device of claim 1, wherein the interconnecting assembly provides a frictional contact between the upper section and the lower section configured to selectively disperse the treats whenever the pet plays with the toy device.

9. The device of claim 1, wherein the mesh member of the lower section is configured to store and disperse at least one of a treat and a medical supplement.
